(19) United States
(12) Patent Application Publication
(10) Pub. No.: US 2003/0160843 A1
(43) Pub. Date: Aug. 28, 2003

(54) Apparatus, method and kit for refillng an ink cartridge

(76) Inventors: Edgard J. Hermes, Broomall, PA (US); Patrick E. Hermes, Broomall, PA (US); Joseph E. Hermes, Broomall, PA (US)

Correspondence Address: Robert S. Lipton, Esquire, LIPTON, WEINBERGER & HUSICK, 201 North Jackson Street, P.O. Box 934, Media, PA, 19063-0934, US

(21) Appl. No.: 10/081,065

(22) Filed: Feb. 25, 2002

(51) Int. Cl. B41J 2/17

(52) U.S. Cl. 347/84

(57) ABSTRACT

The invention comprises an apparatus, method and kit for refilling cartridges of ink jet printers and other printers using liquid ink. A syringe withdraws ink from an ink reservoir through a syringe coupling. A cartridge coupling is installed on a cartridge to be refilled. The cartridge coupling and the syringe coupling are attached to form an ink tight and airtight connection using a bayonet connection with an audible indicator. Ink is injected into the cartridge from the syringe through the couplings. Air is removed from the cartridge using the syringe and the cartridge is ready for use.

### BACKGROUND OF THE INVENTION

1. Field of the Invention

The invention is an apparatus, method and kit for refilling ink cartridges, particularly cartridges for liquid ink used in printers, copiers, word processors, fax machines and the like. The invention also is an ink cartridge equipped to be refilled according to the present invention.

2. Description of the Related Art

The ink jet printer is an inexpensive and popular peripheral for use in personal computer systems. Ink jet printers also are used in many applications where high quality, inexpensive printing is required, such as fax machines, copiers and word processors.

A common type of inkjet technology is “drop on demand.” A motor drive moves a print head across a page or other media to be printed in horizontal strips. A cartridge motor drive rolls the paper in vertical steps. Small droplets of ink are projected through between 300 and 600 nozzles onto paper as the nozzles pass over the paper. Printer driver software controls the operation of the nozzles.

Most inkjets use a thermal technology to project the ink onto the paper. Minute heating elements heat the ink to create a bubble. The pressure created by the bubble ejects ink through a nozzle at the time and location dictated by the printing software. Thermal printing inks must be heat resistant to withstand the heat required to project the ink through a nozzle.

Piezo technology is an alternative to thermal technology. In piezo technology, vibration of a piezo crystal in response to an electrical signal provides the motive force to project ink from the nozzles. Piezo technology inks can be fast drying solvent-based inks and are not required to have the same heat resistance as thermal printing inks.

An ink jet printer can consume a significant quantity of ink. While the initial expense of an ink jet printer is low, the maintenance costs can be quite high due to the short life and high cost of ink cartridges.

The issue of the low capacity of ink jet cartridges has been recognized by the industry and several attempts have been made to rectify the problem. U.S. Pat. No. 4,831,389 to Chan issued on May 16, 1989 teaches large ink reservoirs that wick ink to an ink jet print head by capillary action. U.S. Pat. No. 6,065,828 to Lo issued on May 23, 2000, teaches that a large volume of a single colorless ink vehicle can be delivered to a print head where the vehicle is mixed with multiple concentrated pigments to form finished inks of various colors. In U.S. Pat. No. 6,065,829 to Ruiz issued May 23, 2000, an ink jet print cartridge is connected automatically to an ink supply periodically and ink drawn by vacuum to replenish the print cartridge.

In recent years, the options available to owners of ink jet printers have expanded due to the entry of aftermarket suppliers of ink jet cartridges and due to the availability of commercial recycling and refill services. Kits also are available to allow a consumer to refill certain ink jet cartridges. Whenever a consumer handles ink in bulk, the risk of a spill is present. An ink spill is likely to result in staining and damage.

The prior art patents and kits do not teach the elements of the present invention.

### SUMMARY OF THE INVENTION

The invention is an apparatus, kit and method for refilling of liquid ink cartridges for ink jet printers. The invention also is an ink jet print cartridge equipped to be refilled according to the present invention. In the apparatus of the invention, a syringe is provided. The syringe is equipped with a syringe coupling. The syringe coupling is adapted to engage a cartridge coupling in an ink-tight and airtight manner. The cartridge coupling is attached to the cartridge to be filled and communicates with the ink reservoir of the cartridge. A user may inject ink from the syringe into the ink reservoir of the cartridge through the syringe and cartridge couplings. The ink-tight and airtight junction of the syringe and cartridge couplings prevents the leakage of ink and allows air to be drawn from the cartridge. A valve opens to allow the passage of ink when the cartridge coupling and the syringe coupling are engaged, but closes to prevent escape of ink from the cartridge when the cartridge coupling and syringe coupling are disengaged.

In the kit of the present invention, a syringe having a syringe coupling is provided. Also provided is a cartridge coupling to be attached to the cartridge to be filled. The user may attach the coupling to the cartridge using any available means, such as a bonding agent, which may form a component of the kit. A drill may be included in the kit to allow the consumer to prepare an appropriate hole so that the cartridge coupling may communicate with the ink reservoir of the cartridge. Appropriate ink also may be a component of the kit.

In the method of the present invention, a user affixes a cartridge coupling to a cartridge to be filled so that the cartridge coupling forms an ink-tight and airtight seal with and so that the cartridge coupling communicates with the ink reservoir of the cartridge. The user loads a syringe with ink and engages a syringe coupling on the syringe with the cartridge coupling on the cartridge to create an ink-tight and airtight connection. The user then injects ink from the syringe into the ink reservoir of the cartridge.

### BRIEF DESCRIPTION OF THE DRAWINGS

FIG. 1 is a syringe for injecting ink and withdrawing air from an ink cartridge.

FIG. 2 is an ink storage reservoir.

FIG. 3 is the syringe coupled to the storage reservoir for withdrawing ink.

FIG. 4 is a typical ink cartridge.

FIG. 5 is an ink cartridge to be filled and with a cartridge coupling installed.

FIG. 6 is an ink cartridge being filled with ink from a syringe.

FIG. 7 is a syringe removing air from an ink cartridge.

FIG. 8 is a typical syringe coupling.

FIG. 9 is a typical cartridge coupling.

### DESCRIPTION OF THE PREFERRED EMBODIMENT

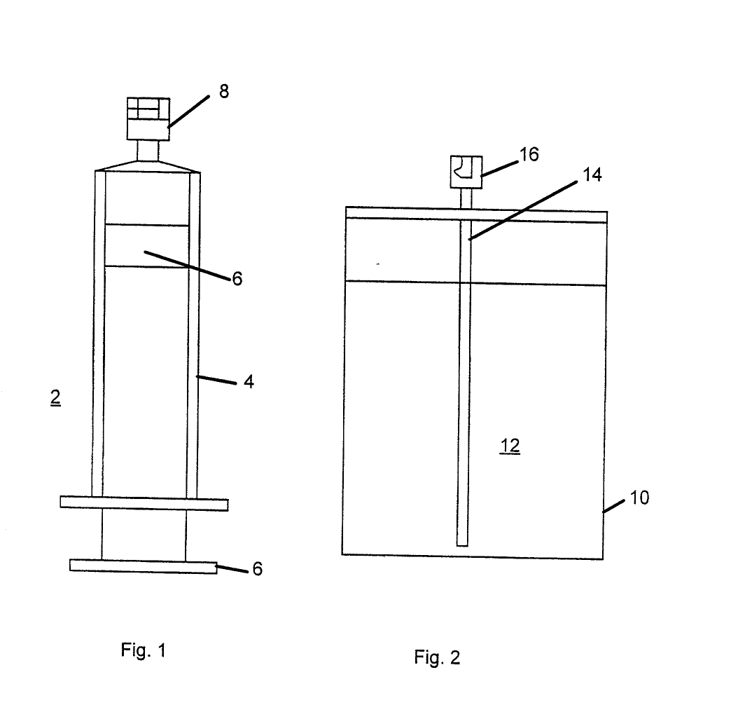

For the apparatus of the present invention and as shown by FIG. 1, a syringe 2 has a syringe body 4 and a plunger 6. A syringe coupling 8 is attached to the syringe so that the attachment is ink tight and airtight. The syringe coupling 8 is attached so that syringe coupling 8 and syringe 2 are in fluid communication and the contents of the syringe 2 may be injected through the syringe coupling 8.

An ink storage reservoir 10 also is provided as shown by FIG. 2. The ink storage reservoir 10 contains ink 12. A withdrawal tube 14 extends into the ink storage reservoir 10. A reservoir coupling 16 is attached to withdrawal tube 14.

Syringe coupling 8 and the reservoir coupling 16 are selected so as to join releasably one to another to form an ink tight and airtight connection and to provide fluid communication between the syringe coupling 8 and the reservoir coupling 16. The preferred syringe coupling 8 and reservoir coupling 16 are coupling set model SMCDO1 manufactured by CPC Colder Products Company, 1001 Westgate Drive, St. Paul, Minn. 55114 and marketed by Konstance Pneumatics Incorporated, 882 South Matlack St., Unit B, West Chester, Pa. 19382. Coupling set SMCD01 is comprised of a male coupling and a female coupling. The male coupling of coupling set SMCDO1 is the preferred syringe coupling 8. The female coupling of coupling set SMCDO1 is the preferred ink reservoir coupling 16.

The male and female couplings of coupling set SMCDO1(and hence syringe coupling 8 and reservoir coupling 16) join together using a positive bayonet connection. An audible indicator in the form of a “click” evidences connection.

Reservoir coupling 16 incorporates a spring-loaded valve controlling fluid flow through the coupling 16. The spring loaded valve is in a closed position when the reservoir coupling 16 is disconnected from the syringe coupling 8, preventing leakage of ink from reservoir 10. The valve spring is depressed when syringe coupling 8 and reservoir coupling 16 are engaged, thereby allowing fluid flow through the syringe coupling 8 and reservoir coupling 16.

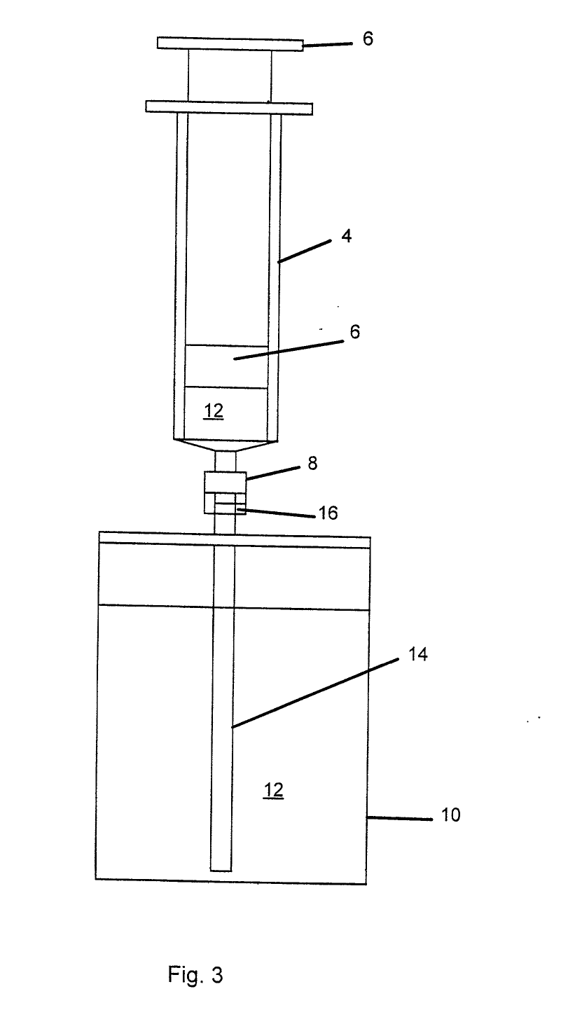

As shown by FIG. 3, syringe 2 is loaded by mating syringe coupling 8 to ink reservoir coupling 16 to form an airtight and ink tight connection, placing syringe 2 in fluid communication with ink reservoir 10. Plunger 6 of syringe 2 is withdrawn, drawing ink 12 from ink reservoir 10 through ink withdrawal tube 14, through reservoir coupling 16 and through syringe coupling 8 into syringe 2.

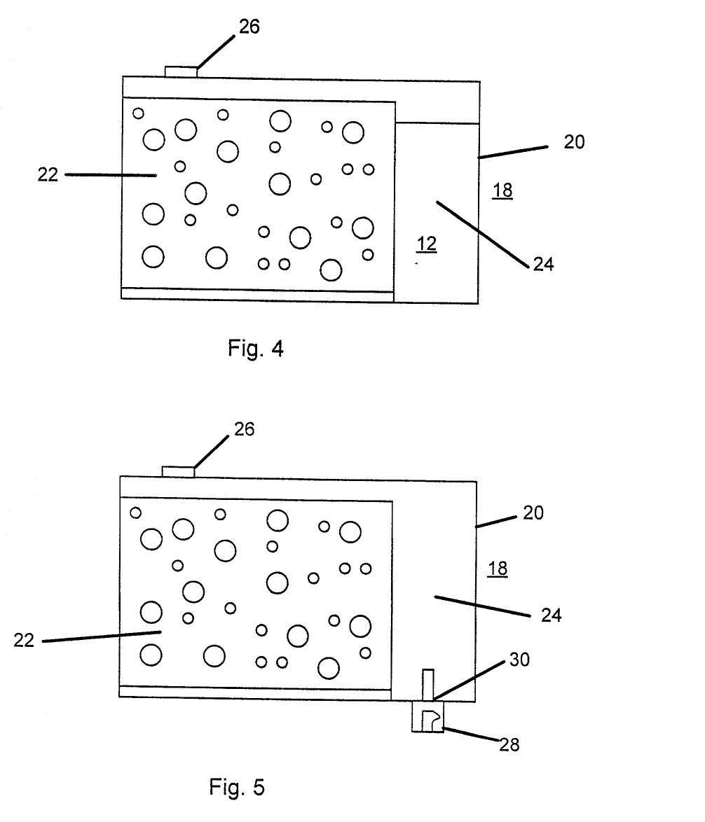

A typical ink cartridge 18 is illustrated by FIG. 4. The typical ink cartridge comprises an outer casing 20, an ink-storing sponge 22, a cartridge reservoir 24 and an ink outlet port 26. Liquid ink 12 is retained in the cartridge reservoir 24 and the sponge 22. The ink outlet port 26 receives ink from the sponge 22 and feeds the ink 12 to the print head of the ink jet printer.

FIG. 5 illustrates a cartridge 18 depleted of ink 12 and ready to be refilled according to the present invention. A cartridge coupling 28 is affixed to cartridge 18. The cartridge coupling 28 is adapted to releasably attach to syringe coupling 8 to form an airtight and ink tight attachment and to provide fluid communication between syringe 2 and cartridge reservoir 24. The cartridge coupling preferably is the female portion of the coupling set model SMCDO1 manufactured by CPC Colder Products Company and is identical to the ink reservoir coupling 16. Cartridge coupling 28 incorporates a bayonet connection and audible indicator identical to that of reservoir coupling 16. Cartridge coupling 28 also incorporates a spring-loaded valve identical to reservoir coupling 16 to present escape of ink 12 from ink cartridge 18.

The cartridge coupling 28 may be affixed to cartridge 18 by any means known to the art. Typically, a small hole 30 is drilled through the body 20 of cartridge 18 and into the cartridge ink reservoir 24. The cartridge coupling 28 may be inserted through the hole 30 in the body 20 of the cartridge 18 and bonded to the cartridge body 20 using bonding agents. The cartridge coupling 28 may be attached to the body 20 of cartridge 18 using any other available means. Such means may include use of threads on the cartridge coupling 28, use of fasteners such as screws or nuts, use of an interference fit between the cartridge coupling 28 and the small hole 30, use of grommets or washers or any other available means for connecting the cartridge coupling 28 and the cartridge casing 20. The location of hole 30 and hence cartridge coupling 28 is selected so as to facilitate filling of the cartridge 18 while avoiding interference with operation of the cartridge 18 when the cartridge 18 is installed in a printer. The cartridge coupling 28 may be molded, pressed or otherwise formed as an integral part of ink cartridge 18,

The example ink jet cartridge 18 of FIGS. 4 and 5 is provided for illustration purposes only. Many ink jet cartridge 18 designs exist. For example, an ink jet cartridge 18 may dispense with sponge 22. In other instances an ink reservoir 24 of an ink cartridge 18 may comprise a distensible bag for holding ink. In such case, the cartridge coupling 28 is affixed to the distensible bag or to structures supporting the distensible bag to provide an airtight and ink tight seal and to provide fluid communication between the interior of the distensible bag and the cartridge coupling 28. The present invention is compatible with a wide variety of ink jet cartridge designs and configurations.

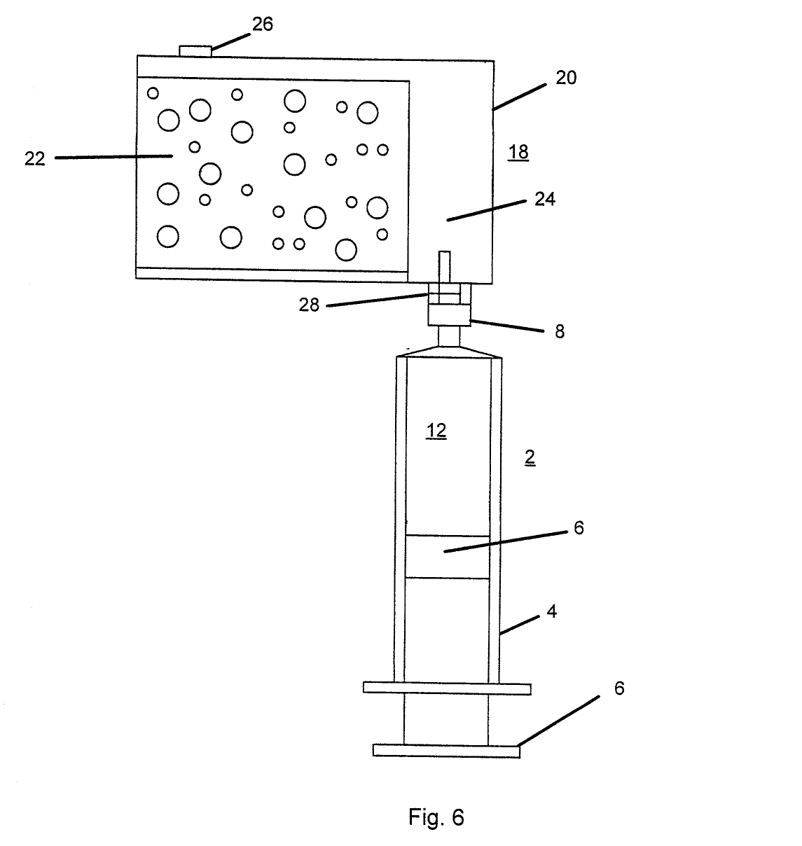

FIG. 6 illustrates filling an ink cartridge 18 using the apparatus, method and kit of the present invention. A syringe 2 that is loaded with ink 12 is provided.

The syringe coupling 8 is attached to the cartridge coupling 26 to form an airtight and ink tight connection and to open a spring-loaded valve incorporated into cartridge coupling 26. The ink cartridge 18 is manipulated such that the outlet port 26 is high in elevation compared to the remainder of the cartridge 18. The plunger 6 of syringe 2 is slowly depressed, forcing ink 12 from the syringe 2 through the syringe coupling 8, through the cartridge coupling 28 and into the cartridge reservoir 24. Sponge 22 absorbs ink 12 in cartridge reservoir 24. The ink 12 absorbed by sponge 22 is available for printing through outlet port 26.

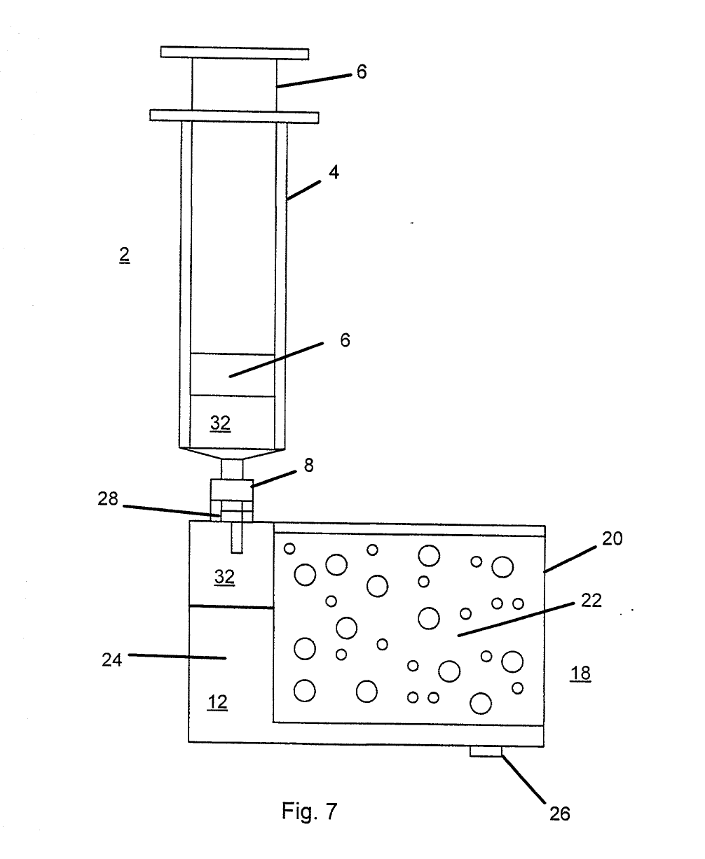

As shown by FIG. 7, the remaining step in refilling cartridge 18 is to withdraw air from the cartridge 18. The cartridge 18 and attached syringe 2 are manipulated so that the cartridge coupling 28 is high in elevation compared to the remainder of the cartridge 18. The plunger 6 of syringe 2 is slowly withdrawn, drawing air 32 from the cartridge 18 and into the syringe 2. The cartridge coupling 26 is disengaged from the syringe coupling 8, closing the spring-loaded valve incorporated in cartridge coupling 26 and preventing leakage of ink 12.

The refilled cartridge 18 is inserted in a printer and allowed to proceed through the printer cycle. The refilling is complete and the cartridge 18 is ready for printing.

A kit for use in refilling ink jet cartridges may include ink 12, a syringe 18, a syringe coupling 8 and a cartridge coupling 28. A kit also may include an ink reservoir 10 and a reservoir coupling 19. The manufacturer may load the syringe 2 with a predetermined amount of ink 12. The kit may include a drill or other means for making a hole 30 in the case 20 of cartridge 18. The kit may include a bonding agent to secure cartridge coupling 28 to cartridge 18. Alternately, the kit may dispense with cartridge coupling 28, drill, and adhesive and instead include cartridge 18 already equipped with cartridge coupling 28.

Syringe 2 preferably is graduated so the syringe 2 may be loaded with an amount of ink 12 appropriate for a cartridge to be filled 18.

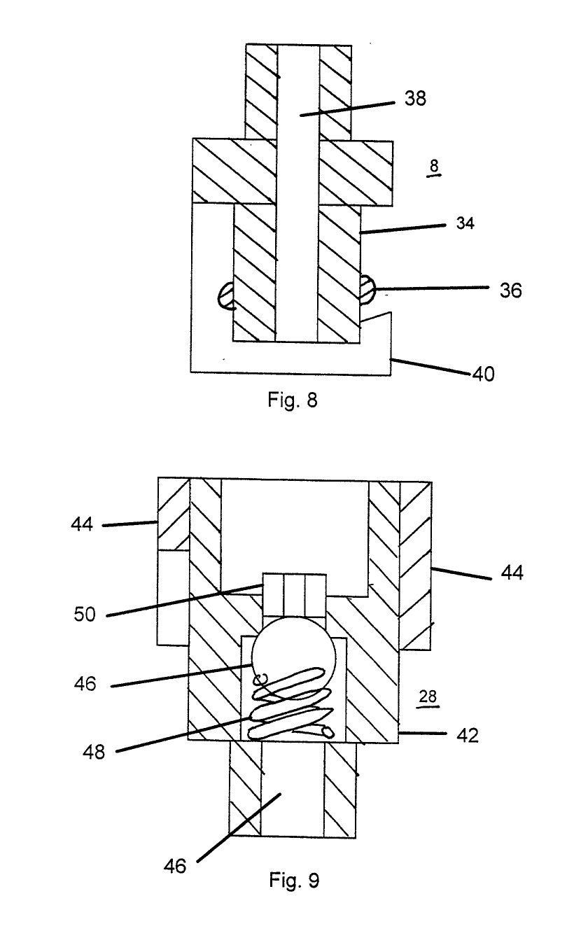

FIG. 8 shows a typical syringe coupling 8. A syringe coupling body 34 defines a syringe orifice 38 for fluid communication. An O-ring 36 provides an airtight and ink tight seal when the syringe coupling 8 is engaged with a cartridge coupling 28. A syringe bayonet fitting 40 positively maintains engagement between the syringe coupling 8 and the cartridge coupling 28.

FIG. 9 shows a typical cartridge coupling 28, which is identical to a reservoir coupling 16. A cartridge coupling body 42 defines a cartridge coupling orifice 46 for fluid communication. Cartridge bayonet fitting 44 positively maintains engagement between syringe coupling 8 and cartridge coupling 28. Ball valve 46 is maintained in a normally closed position by spring 48. When cartridge coupling 28 and syringe coupling 8 are engaged, valve release 50 is actuated by syringe coupling body 34, opening ball valve 46 and allowing fluid communication through cartridge coupling orifice 46.

Many different embodiments of the above invention are possible. This application is intended to address all possible embodiments and is limited only as described in the following claims.

I claim:

1. An apparatus for refilling a printer cartridge with ink comprising:
a. a syringe; and
b. a syringe coupling in fluid communication with said syringe such that said ink may pass from said syringe through said syringe coupling; and
c. a cartridge coupling releasably engaging and in fluid communication with said syringe coupling such that said ink may pass from said syringe coupling to said cartridge coupling when said syringe coupling and said cartridge coupling are engaged, said cartridge coupling being in fluid communication with said ink cartridge such that said ink may pass from said cartridge coupling into said ink cartridge.

2. The apparatus of claim 1, said communication and engagement of said cartridge coupling to said syringe coupling being airtight and ink tight, such that neither ink nor air may escape from said syringe and cartridge couplings when said syringe and cartridge couplings are engaged.

3. The apparatus of claim 2, said fluid communication between said cartridge coupling and said cartridge being controlled by a valve, said valve having an open position allowing passage of said ink through said cartridge coupling and a closed position blocking passage of said ink through said cartridge coupling, said valve being in said open position when said cartridge coupling and said syringe coupling are engaged, said valve being in said closed position when said syringe coupling and said cartridge coupling are not engaged .

4. The apparatus of claim 3, said valve being airtight when said valve is in said closed position such that air may not enter said cartridge through said cartridge coupling.

5. The apparatus of claim 4, said syringe being graduated to allow an amount of said ink appropriate for said printer cartridge to be loaded into said syringe.

6. The apparatus of claim 5 further comprising:
a. an ink reservoir containing said ink; and
b. a reservoir coupling communicating to said ink reservoir and adapted for connection with said syringe coupling such that said syringe and said ink reservoir may be placed in fluid communication when said reservoir coupling and said syringe coupling are connected so that said syringe may be loaded with said ink from said ink reservoir.

7. The apparatus of claim 6, said engagement of said syringe coupling and said cartridge coupling comprising a bayonet engagement, said engagement being evidenced by an audible indicator.

8. An ink jet cartridge comprising:
a. a cartridge reservoir; and
b. a cartridge coupling in fluid communication with said cartridge reservoir, said cartridge coupling being adapted to form a releasable airtight and ink tight seal with a syringe coupling such that said cartridge reservoir may be placed in fluid communication with a syringe through said syringe coupling to allow said cartridge reservoir to be filled with an ink from said syringe.

9. The ink jet cartridge of claim 8 further comprising a valve, said valve controlling said fluid communication between said syringe and said cartridge, said valve having an open position allowing passage of said ink and a closed position blocking passage of said ink, said valve being in said open position when said cartridge coupling and said syringe coupling are engaged, said valve being in said closed position when said syringe coupling and said cartridge coupling are not engaged

10. A method for refilling an ink cartridge comprising the steps of:
a. affixing a cartridge coupling to said ink cartridge such that said cartridge coupling is in fluid communication with said ink cartridge; and
b. engaging a syringe coupling to said cartridge coupling, said syringe coupling being in fluid communication with an ink-containing syringe; and
c. injecting ink from said syringe through said syringe coupling and said cartridge coupling into said ink cartridge.

11. The method of claim 10, said fluid communication between said cartridge coupling and said ink cartridge being controlled by a valve, said valve having an open position allowing passage of said ink and a closed position blocking passage of said ink, said valve being in said open position when said cartridge coupling and said syringe coupling are engaged, said valve being in said closed position when said syringe coupling and said cartridge coupling are not engaged.

12. The method of claim 11, said cartridge having a cartridge body defining an ink reservoir, said affixing of said cartridge coupling to said ink cartridge comprising:
a. drilling a hole through said body into said ink reservoir; and
b. aligning said cartridge coupling with said hole; and
c. applying means to attach said cartridge coupling to said cartridge body.

13. The method of claim 12, said means for attaching said cartridge coupling to said cartridge body comprising bonding said cartridge coupling and said cartridge body.

14. The method of claim 13, said cartridge having an outlet port, said syringe having a plunger slideably engaging a syringe body, said injecting of said ink comprising the steps of:
a. manipulating said cartridge so that said outlet port is higher in elevation than substantially the remainder of said print cartridge; and
b. depressing slowly said plunger of said syringe, thereby applying a positive pressure to said ink in said syringe and injecting said ink into said cartridge reservoir.

15. The method of claim 14 comprising the additional step of loading said syringe with said ink prior to engaging said syringe and cartridge couplings.

16. The method of claim 15 comprising the additional step of removing air from said cartridge after injecting said cartridge with said ink.

17. The method of claim 16, the step of removing air comprising the steps of:
a. manipulating said cartridge such that said cartridge coupling is higher in elevation than substantially the remainder of said cartridge; and
b. withdrawing said plunger, thereby applying a partial vacuum to said cartridge coupling and pulling said air from said cartridge.

18. The method of claim 17, said engagement of said syringe and said cartridge couplings comprising a bayonet engagement, said engagement being evidenced by an audible indicator.

19. A method for refilling an ink cartridge having a cartridge body defining a cartridge reservoir, said ink cartridge further having a cartridge coupling in fluid communication with said cartridge reservoir, comprising the steps of:
a. engaging a syringe coupling to said cartridge coupling, said syringe coupling being in fluid communication with an ink-containing syringe; and
b. injecting ink from said syringe through said syringe coupling and said cartridge coupling into said ink reservoir of said ink cartridge.

20. The method of claim 19, said fluid communication between said cartridge coupling and said cartridge reservoir being controlled by a valve, said valve having an open position allowing passage of said ink and a closed position blocking passage of said ink, said valve being in said open position when said cartridge coupling and said syringe coupling are engaged, said valve being in said closed position when said syringe coupling and said cartridge coupling are not engaged.

21. The method of claim 20, said ink cartridge having an outlet port, said syringe having a plunger slideably engaging a syringe body, said injecting of said ink comprising the steps of:
a. manipulating said cartridge so that said outlet port is higher in elevation than substantially the remainder of said cartridge; and
b. depressing slowly said plunger of said syringe, thereby applying a positive pressure to said ink in said syringe and injecting said ink into said cartridge reservoir.

22. The method of claim 21 comprising the additional step of loading said syringe with said ink prior to engaging said syringe and cartridge couplings.

23. The method of claim 22 comprising the additional step of removing air from said cartridge after injecting said cartridge with said ink.

24. The method of claim 23, the step of removing air comprising the steps of:
a. manipulating said ink cartridge such that said cartridge coupling is higher in elevation than substantially the remainder of said ink cartridge; and
b. withdrawing said plunger, thereby applying a partial vacuum to said cartridge coupling and pulling said air from said cartridge reservoir.

25. The method of claim 24, said engagement of said syringe and said cartridge couplings comprising a bayonet engagement, said engagement being evidenced by an audible indicator.

26. A kit for refilling of an ink cartridge comprising:
a. a syringe, said syringe having a syringe body and a plunger slideably engaging said syringe body, said syringe body and plunger defining a syringe interior volume; and
b. a syringe coupling in fluid communication with said syringe interior volume; and
b. a cartridge coupling adapted to be affixed to an ink cartridge such that said cartridge coupling is in fluid communication with said ink cartridge, said cartridge coupling being adapted to releasably engage said syringe coupling.

27. The kit of claim 26, said fluid communication between said cartridge coupling and said ink cartridge being controlled by a valve, said valve having an open position allowing passage of said ink and a closed position blocking passage of said ink, said valve being in said open position when said cartridge coupling and said syringe coupling are engaged, said valve being in said closed position when said syringe coupling and said cartridge coupling are not engaged.

28. The kit of claim 27 further comprising:
a. an ink adapted to be loaded into said syringe and injected into said cartridge; and
b. an ink reservoir containing said ink; and
c. a reservoir coupling in fluid communication with said ink reservoir, said reservoir coupling adapted to releasably engage said syringe coupling to form an airtight and ink tight connection so that said ink may be drawn from said ink reservoir by said syringe when said reservoir coupling and said syringe coupling are engaged.

29. The kit of claim 28, said ink cartridge having a cartridge body, said cartridge body defining a cartridge reservoir, further comprising means for affixing said cartridge coupling to said ink cartridge so that said cartridge coupling is in fluid communication with said cartridge ink reservoir while providing an ink-tight and air-tight seal with said cartridge ink reservoir.

30. The kit of claim 29, said means for affixing said cartridge coupling comprising:
a. a drill adapted to create a hole through said body for fluid communication between said cartridge coupling and said cartridge ink reservoir; and
b. a bonding agent adapted to secure said cartridge coupling to said body such that said cartridge coupling is in fluid communication with said cartridge ink reservoir through said hole.

31. The kit of claim 30 further comprising said engagement between said syringe coupling and said cartridge coupling and between said syringe coupling and said reservoir coupling being a bayonet engagement wherein engagement is evidenced by an audible indicator.

32. An ink cartridge kit comprising:
a. a syringe, said syringe having a syringe body and a plunger slideably engaging said syringe body, said syringe body and plunger defining a syringe interior volume, said syringe having a syringe coupling in fluid communication with said syringe interior volume; and
b. an ink cartridge having a cartridge body, said cartridge body defining a cartridge reservoir, said ink cartridge having a cartridge coupling being in fluid communication with said cartridge reservoir, said cartridge coupling being adapted to releasably engage said syringe coupling in an airtight and ink tight connection and to thereby place said cartridge reservoir and said syringe interior volume in fluid communication such that an ink may be injected from said syringe into said cartridge reservoir.

33. The kit of claim 32 said fluid communication between said cartridge coupling and said cartridge reservoir being controlled by a valve, said valve having an open position allowing passage of said ink and a closed position blocking passage of said ink, said valve being in said open position when said cartridge coupling and said syringe coupling are engaged, said valve being in said closed position when said syringe coupling and said cartridge coupling are not engaged

34. The kit of claim 33 further comprising:
a. an ink adapted to be loaded into said syringe and injected into said cartridge; and
b. an ink reservoir containing said ink; and
c. a reservoir coupling in fluid communication with said ink reservoir, said reservoir coupling adapted to releasably engage said syringe coupling to form an airtight and ink tight connection so that said ink may be drawn from said ink reservoir by said syringe when said reservoir coupling and said syringe coupling are engaged.

35. The kit of claim 33 further comprising said engagement between said syringe coupling and said cartridge coupling and between said syringe coupling and said reservoir coupling being a bayonet engagement wherein engagement is evidenced by an audible indicator.
